(19) United States
(12) Patent Application Publication
(10) Pub. No.: US 2018/0284557 A1
(43) Pub. Date: Oct. 4, 2018

(54) ELECTROCHEMICAL MIRROR

(71) Applicant: SAMSUNG ELECTRONICS CO., LTD., Suwon-si (KR)

(72) Inventor: Young-soo KIM, Suwon-si (KR)

(73) Assignee: SAMSUNG ELECTRONICS CO., LTD., Suwon-si (KR)

(21) Appl. No.: 15/933,973

(22) Filed: Mar. 23, 2018

(30) Foreign Application Priority Data
Apr. 3, 2017 (KR) 10-2017-0043092

(51) Int. Cl. G02F 1/19

(52) U.S. Cl. CPC G02F 1/19

(57) ABSTRACT

Provided is an electrochemical mirror that includes a first electrode; a second electrode; and an electrolyte between the first electrode and the second electrode. The electrolyte includes hydrophilic inorganic particles; a first metal compound including a first metal capable of being deposited and a second metal compound including a second metal different from the first metal and capable of being deposited.

### CROSS-REFERENCE TO RELATED APPLICATION

This application is based on and claims priority under 35 U.S.C. § 119 to Korean Patent Application No. 10-2017-0043092, filed on Apr. 3, 2017, in the Korean Intellectual Property Office, the disclosure of which is incorporated by reference herein in its entirety.

### BACKGROUND

### 1. Field

The disclosure relates generally to an electrochemical mirror.

### 2. Description of Related Art

Electrochemical mirrors are capable of selectively switching between a reflection mode and a transmission mode according to an applied voltage. Depending on a type of an electrolyte between electrodes, electrochemical mirrors are classified as a solid electrolyte type or a liquid electrolyte type. The liquid electrolyte type costs less than the solid electrolyte type, and preparation of the liquid electrolyte type may be simple. In the liquid electrolyte type, selective switching between a reflection mode and a transmission mode is performed by an electrochemical reaction through which a metal capable of being deposited is deposited and stripped on an electrode.

Studies are underway to improve performance of an electrochemical mirror by improving reversibility of an electrochemical reaction involved in switching of the electrochemical mirror.

### SUMMARY

In accordance with an aspect of the disclosure an electrochemical mirror is provided which has an improved switching speed between a reflection mode and a transmission mode, improved mirror uniformity, and improved lifespan characteristics by including an electrolyte that has a novel composition.

Additional aspects will be set forth in part in the description which follows and, in part, will be apparent from the description, or may be learned by practice of exemplary embodiments.

According to an aspect of an exemplary embodiment, an electrochemical mirror includes a first electrode; a second electrode; and an electrolyte between the first electrode and the second electrode, where the electrolyte includes hydrophilic inorganic particles; a first metal compound including a first metal, the first metal capable of being deposited; and a second metal compound including a second metal different from the first metal, the second metal capable of being deposited.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic diagram illustrating a reaction mechanism of an electrochemical mirror during formation of a mirror layer, according to an embodiment;

FIG. 2A is a schematic view illustrating an electrochemical mirror in a transmission mode, according to another embodiment;

FIG. 2B is a schematic view illustrating an electrochemical mirror in a reflection mode, according to another embodiment;

FIG. 3 is an image illustrating whether phase separation occurred in an electrolyte solution including hydrophilic inorganic particles (the vial on the left) and an electrolyte solution including hydrophobic inorganic particles (the vial on the right);

FIG. 4A is a view illustrating a cyclic voltammogram of an electrochemical mirror prepared in Example 1;

FIG. 4B is a view illustrating a cyclic voltammogram of electrochemical mirrors prepared in Examples 3 to 5;

FIG. 5 is a view illustrating Nyquist plots that show the results of impedance measurement of electrochemical mirrors prepared in Example 1 and Comparative Example 1 in a reflection mode;

FIG. 6A is an image illustrating the electrochemical mirror of Example 1, in a transmission mode, to which a voltage is not applied according to an embodiment;

FIG. 6B is an image illustrating the electrochemical mirror of Example 1, in a reflection mode, 10 seconds after a point of voltage application according to an embodiment;

FIG. 7A is a graph illustrating a reduction current and an oxidation current over time during 1000 cycles of switching performed by the electrochemical mirror of Example 1;

FIG. 7B is an image illustrating the electrochemical mirror of Example 1 in transmission mode after performing 1000 cycles of switching;

FIG. 7C is a graph illustrating a reduction current and an oxidation current over time during 1000 cycles of switching performed by an electrochemical mirror of Example 6;

FIG. 7D is an image illustrating the electrochemical mirror of Example 6 in transmission mode after performing 1000 cycles of switching;

FIG. 7E is a graph illustrating a reduction current and an oxidation current over time during 1000 cycles of switching performed by an electrochemical mirror of Comparative Example 2;

FIG. 7F is an image illustrating the electrochemical mirror of Comparative Example 2 in transmission mode after performing 1000 cycles of switching;

FIG. 8A is an image illustrating the electrochemical mirror of Example 1 in an initial transmission mode;

FIG. 8B is an image illustrating the electrochemical mirror of Example 1 in a reflection mode after 600 cycles of switching;

FIG. 8C is an image illustrating the electrochemical mirror of Example 6 in an initial transmission mode;

FIG. 8D is an image illustrating the electrochemical mirror of Example 6 in a reflection mode after 600 cycles of switching;

FIG. 8E is an image illustrating the electrochemical mirror of Comparative Example 2 in an initial transmission mode; and

FIG. 8F is an image illustrating the electrochemical mirror of Comparative Example 2 in a reflection mode after 600 cycles of switching.

### DETAILED DESCRIPTION OF EXEMPLARY EMBODIMENTS

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, as the present inventive concept allows for various changes and numerous exemplary embodiments, particular embodiments will be illustrated in the drawings and described in detail in the written description. However, this is not intended to limit the present inventive concept to particular modes of practice, and it is to be appreciated that all changes, equivalents, and substitutes that do not depart from the spirit and technical scope are encompassed in the present inventive concept.

The terms used herein are merely used to describe exemplary embodiments, and are not intended to limit the present inventive concept. An expression used in the singular encompasses the expression of the plural, unless it has a clearly different meaning in the context. As used herein, it is to be understood that the terms such as “including,” “having,” and “comprising” are intended to indicate the existence of the features, numbers, steps, actions, components, parts, ingredients, materials, or combinations thereof disclosed in the specification, and are not intended to preclude the possibility that one or more other features, numbers, steps, actions, components, parts, ingredients, materials, or combinations thereof may exist or may be added. The term “I” used herein may be interpreted as “and” or “or” according to the context.

In the drawings, the thicknesses of layers and regions are exaggerated or reduced for clarity. Like reference numerals in the drawings denote like elements, and thus their description will be omitted. Throughout the specification, it will be understood that when a component, such as a layer, a film, a region, or a plate, is referred to as being “on” another component, the component can be directly on the other component or intervening components may be present thereon. Throughout the specification, while such terms as “first,” “second,” etc., may be used to describe various components, such components must not be limited to the above terms. The above terms are used only to distinguish one component from another.

Hereinafter, unless explained otherwise, the term “electrolyte” in an electrochemical mirror denotes a liquid electrolyte. The liquid electrolyte is at least one of a liquid state or a gel state.

Hereinafter, an electrochemical mirror according to one or more embodiments will be described.

According to an exemplary embodiment, an electrochemical mirror includes a first electrode; a second electrode; and an electrolyte between the first electrode and the second electrode, wherein the electrolyte includes hydrophilic inorganic particles; a first metal compound including a first metal, the first metal capable of being deposited; and a second metal compound including a second metal different from the first metal, the second metal capable of being deposited.

When the electrochemical mirror includes the electrolyte including the hydrophilic inorganic particles, the first metal compound, and the second metal compound, reversibility of an electrochemical reaction involved in switching of the electrochemical mirror may increase. Thus, a switching speed, mirror uniformity, and lifespan characteristics of the electrochemical mirror may improve.

The hydrophilic inorganic particles are inorganic particles having affinity to a polar solvent such as water or an organic solvent. The hydrophilic inorganic particles are easily wetted in a polar solvent, and a contact angle of the hydrophilic inorganic particles to a polar solvent is low. For example, a contact angle of a thin film constituted of the hydrophilic inorganic particles to water may be less than 90°, less than 80°, less than 70°, less than 60°, less than 50°, less than 40°, less than 30°, or less than 20°.

The hydrophilic inorganic particles may include a hydrophilic functional group on a particle surface. The hydrophilic functional group may be a polar functional group. The hydrophilic functional group may be at least one selected from —OH, —(C═O)—OH, —(C═O)—H, —NH₂, —(C═O)—NH₂, —R—OH, —R—(C═O)—OH, —R—(C═O)—H, —R—NH₂, and —R—(C═O)—NH₂, but exemplary embodiments are not limited thereto, and any functional group available as a hydrophilic functional group in the art may be used. In the hydrophilic functional group, R is an unsubstituted or substituted C1-C20 alkylene group, an unsubstituted or substituted C6-C20 arylene group, an unsubstituted or substituted C3-C20 heteroarylene group, an unsubstituted or substituted C4-C20 cycloalkylene group, or an unsubstituted or substituted C3-C20 heterocycloalkylene group. Particularly, the hydrophilic functional group may be —OH or —(CH₂)ₙ—OH (where n is an integer of 1 to 20).

For example, the hydrophilic inorganic particles may be one or more metal oxides represented by Formula 1, a mixture thereof, a composite thereof, or a combination thereof:

MₐO_{b} Formula 1

In Formula 1, 1≤a≤2 and 1≤b≤4; and M is at least one element that belongs to Group 2 to Group 14.

For example, the hydrophilic inorganic particles may be one or more metal oxides represented by Formula 2, a mixture thereof, a composite thereof, or a combination thereof:

M′_{c}O_{d} Formula 2

In Formula 2, 1≤c≤2 and 1≤d≤3; and M′ is at least one element selected from Si, Al, Ti, Mg, Ba, Zr, and Zn.

In particular, the hydrophilic inorganic particles may be metal oxides such as SiO₂, TiO₂, Mg(OH)₂, MgO₂, ZrO₂, ZnO, Al₂O₃, or BaTiO₃; a mixture thereof; a composite thereof; or a combination thereof. For example, the hydrophilic inorganic particles may be a composite in which a metal oxide is doped on another metal oxide.

The hydrophilic inorganic particles may be nanoparticles (NPs) or an agglomerate of nanoparticles. The nanoparticles may be primary particles having an average particle diameter in a range of about 5 nm to about 200 nm, about 5 nm to about 150 nm, about 5 nm to about 100 nm, about 10 nm to about 80 nm, or about 20 nm to about 70 nm. The average particle diameter of the primary particles may be measured from a transmission electron microscope image including a plurality of primary particles or may be a D50 value measured by using a light scattering method. The agglomerate of nanoparticles may be secondary particles having an average particle diameter in a range of about 50 nm to about 50 μm, about 50 nm to about 30 μm, about 50 nm to about 20 μm, about 50 nm to about 10 μm, about 100 nm to about 5 μm, or about 300 nm to about 3 μm. The average particle diameter of the secondary particle may be a D50 value measured by using a light scattering method. The D50 value is a particle diameter at a point corresponding to 50% of a cumulative value in a particle size distribution.

A specific surface area of the hydrophilic inorganic particles may be 150 m²/g or lower. A specific surface area of the hydrophilic inorganic particles may be in a range of about 1 m²/g to about 150 m²/g, about 1 m²/g to about 120 m²/g, about 1 m²/g to about 100 m²/g, about 3 m²/g to about 90 m²/g, about 5 m²/g to about 80 m²/g, about 10 m²/g to about 70 m²/g, about 20 m²/g to about 70 m²/g, or about 30 m²/g to about 70 m²/g. Also, a low specific surface area of the hydrophilic inorganic particles does not substantially affect an increase in a viscosity of the electrolyte, and thus the hydrophilic inorganic particles do not function as a curing agent that accompanies a chemical network.

An amount of the hydrophilic inorganic particles may be in a range of about 0.1 wt % to about 20 wt %, about 0.1 wt % to about 15 wt %, about 0.1 wt % to about 10 wt %, about 0.1 wt % to about 8 wt %, about 0.3 wt % to about 6 wt %, or about 0.5 wt % to about 5 wt %. When the amount of the hydrophilic inorganic particles is less than 0.1 wt % based on the total weight of the electrolyte, an effect of the electrolyte on improvement of performance of the electrochemical mirror may be insignificant. When the amount of the hydrophilic inorganic particles is more than 20 wt %, precipitation caused by aggregation of the hydrophilic inorganic particles may occur.

The hydrophilic inorganic particles may be dispersed without phase separation in the electrolyte. On the other hand, hydrophobic inorganic particles may have phase separation without stably being dispersed in the electrolyte. The hydrophilic inorganic particles may be homogeneously dispersed in the electrolyte and form a stable phase, but the hydrophobic inorganic particles may not be used in an electrolyte since the hydrophobic inorganic particles may not maintain a stable phase within the electrolyte and are separated into another phase that is distinguished from the electrolyte.

Due to the hydrophilic inorganic particles being involved in reduction or oxidation of at least one of the first metal and second metal that are capable of being deposited in the electrolyte, reversibility of an electrochemical reaction may improve. Stable deposition and stripping of the cations of the first metal and/or the second metal may be induced through attractive interaction of the hydrophilic inorganic particles with cations of the first metal and the second metal. Also, the hydrophilic inorganic particles stabilize anions in the electrolyte through attractive interaction with the anions, and thus a side reaction of the anions may be suppressed. For example, when the hydrophilic inorganic particles are involved in the electrochemical reaction of first metal cations and/or second metal cations to cause a lower an activation energy (Ea) or to increase a reaction rate of the electrochemical reaction, deposition and stripping speeds of the cations of the first metal and/or the second metal may increase. The attractive interaction may be intermolecular force, electrostatic interaction, pi (π)-interaction, Van der Waals Force, a hydrogen bond, anion absorption, or a combination thereof, but embodiments are not limited thereto, and any interaction that may affect an electrochemical reaction of ions dissolved in the electrolyte.

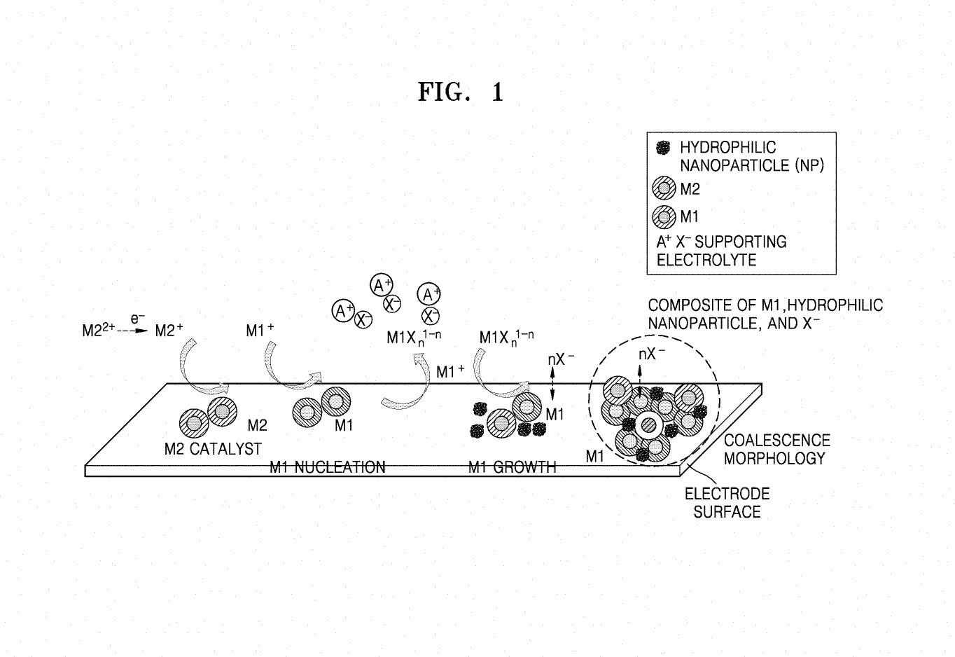

The electrochemical mirror includes a mirror layer on the first electrode or the second electrode by deposition of the first metal and the second metal, and the mirror layer may include the hydrophilic inorganic particles. Since the hydrophilic inorganic particles are involved in the electrochemical reaction through which the first metal and the second metal are electrodeposited, the mirror layer formed by the deposition of the first metal and the second metal may include the hydrophilic inorganic particles. Referring to FIG. 1, when a cation of the first metal (M1), a cation of the second metal (M2), and a complex (M1Xₙ¹⁻ⁿ) of the first metal and an anion of supporting electrolyte (A⁺X⁻) are reduced and electrodeposited, the hydrophilic inorganic particles, that is, hydrophilic nanoparticles (NPs), having attractive interaction with the cation of the first metal (M1), the cation of the second metal (M2), and the complex (M1Xₙ¹⁻ⁿ), may form a composite on an electrode surface. Therefore, the first metal (M1), the second metal (M2), and the hydrophilic nanoparticles (NPs) may have a coalescence morphology. During the deposition process, the second metal (M2) may act as a catalyst that promotes nucleation and growth of the first metal. Also, during the deposition process, the second metal (M2) may form an alloy with the first metal (M1).

The electrochemical mirror may include hydrophilic particles or a hydrophilic layer in a manner different from dispersing the hydrophilic inorganic particles in the electrolyte. The electrochemical mirror may further include a coating layer on a surface of at least one of the first electrode and the second electrode, and the coating layer may include a hydrophilic moiety such as a hydrophilic functional group. In the preparation of the electrochemical mirror, once the coating layer including a hydrophilic component is introduced onto a surface of at least one of the first electrode and the second electrode, the electrolyte may be disposed between the first electrode and the second electrode. The electrolyte may or may not include a hydrophilic component and/or hydrophilic particles. When the coating layer including the hydrophilic component is disposed on a portion of or the whole of the first electrode or the second electrode, attractive interaction between the first metal cation, the second metal cation, and the hydrophilic component may increase on a surface of the first electrode or the second electrode. In this regard, reversibility of the electrochemical reaction may further improve, a rate of forming and removing the mirror layer on the first electrode or the second electrode may increase, and a side reaction may be suppressed. A method of introducing the coating layer may be spin coating, spray coating, dip coating, or surface modification through plasma treatment, but embodiments are not limited thereto, and any method that may form a uniform and stable coating layer on an electrode in the art may be used. A thickness of the coating layer may be in a range of about 10 nm to about 10 μm, about 20 nm to about 5 μm, about 50 nm to about 3 μm, or about 100 nm to about 1 μm, but embodiments are not limited thereto, and any range of thicknesses that may improve reversibility of the electrochemical mirror may be used.

The first metal compound may be an ionic compound including at least one depositable first metal selected from Ag, Au, Mg, Ni, Bi, Cr, Cr, Sr, and Al, but embodiments are not limited thereto, and any material available as a depositable metal in the art or any ionic compound that may manufacture a metal layer having a high reflectivity with respect to white light may be used. The first metal compound may be an ionic salt that may be dissociated into a first metal cation and an anion in the electrolyte. The first metal compound may be a halide of the first metal, a pseudohalide of the first metal, a sulfate of the first metal, a halogenated sulfate of the first metal, or a nitrate of the first metal. For example, the first metal compound may be a nitrate of the first metal. The first metal that is capable of being deposited may be Ag in terms of a high reflectivity of a mirror with respect to white light.

The second metal compound may be an ionic compound including an depositable second metal that is different from the first metal. The second metal compound may be an ionic salt that may be dissociated into a second metal cation and an anion in the electrolyte. The second metal compound may be a second metal halide or a second metal pseudohalide. For example, the second metal compound may be a halide of the second metal.

An absolute value of a reduction potential of the second metal may be smaller than an absolute value of a reduction potential of the first metal. Since the second metal is reduced first at a reduction potential lower than that of the first metal, a nuclear may be formed on an electrode surface, which may thus promote growth of the first metal. The second metal and the first metal may together form an alloy, and thus a uniform mirror phase may be manufactured. In terms of a reduction potential difference with the first metal and easiness of alloy formation, the second metal that is capable of being deposited may be Cu, Ca, Sr, Fe, Sn, or a combination thereof. For example, the second metal compound may be at least one selected from CuBr₂, CuCl₂, and CuF₂. An amount of the second metal compound with respect to the first metal compound may be in a range of about 1:0.1 to about 1:0.3, or, for example, 1:0.2, in a molar ratio. An amount of the second metal compound may be in a range of about 1 mM to about 20 mM, about 3 mM to about 15 mM, or about 5 mM to about 15 mM. An electrolyte that does not include the second metal compound may have deteriorated reversibility of an electrochemical reaction, and thus uniformity and lifespan characteristics of the electrochemical mirror may deteriorate.

The electrolyte may further include at least one selected from a halogen salt, a polymer, and a solvent, in addition to the hydrophilic inorganic particles, the first metal compound, and the second metal compound.

The electrolyte may include a halogen salt as a supporting salt, i.e., supporting electrolyte. The supporting salt may provide a sufficient anion concentration in the electrolyte and thus may assist deposition and stripping of the first metal and the second metal. Also, an anion of the supporting salt may form a composite together with the first metal and the second metal, and thus stability of a mirror phase may improve. The halogen salt may be solid or liquid at room temperature. The halogen salt may be a halogen solid salt including an alkali metal and a cation selected from ammonium-based cations. For example, the halogen salt may be at least one selected from LiBr, NaBr, KBr, tetrabutylammoniumbromide (TBABr), and tetraethylammoniumbromide (TEABr), but embodiments are not limited thereto, and any material that is electrochemically stable within a driving voltage range of an electrochemical mirror and available in the art may be used. The halogen salt may be a halogen ionic liquid including a cation selected from a pyrrolidinium-based cation, a pyridinium-based cation, a piperidinium-based cation, and an imidazolium-based cation. For example, the halogen salt may be at least one selected from 1-ethyl-methylimidazoliumbromide (EMIMBr), 1-methyl-4-hexylimidazoliumbromide (MHIMBr), 1-butyl-4-ethylimidazoliumbromide (BEIMBr), 1-butyl-4-hexylimidazoliumbromide (BHIMBr), 1-butyl-4-dodecylimidazoliumbromide (BDIMBr), and N-butyl-methyl-pyrrolidiniumbromide (NBMPBr), but embodiments are not limited thereto, and any material that is electrochemically stable within a driving voltage range of an electrochemical mirror and available in the art may be used. An amount of the halogen salt with respect to the first metal compound may be in a range of about 1:4 to about 1:6, or, for example, 1:5. An amount of the halogen salt may be in a range of about 5 mM to about 5 M, about 25 mM to about 1 M, about 50 mM to about 1 M, or about 50 mM to about 500 mM.

The solvent in the electrolyte may be a polar aqueous solvent such as water, a non-aqueous organic solvent, or a mixture thereof. The non-aqueous organic solvent may be a polar solvent or a non-polar solvent. The solvent may be at least one selected from water, dimethylsulfoxide (DMSO), propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, dimethylether, diethylether, γ-butyrolactone, dioxolane, 4-methyldioxolane, N,N-dimethylformamide, dimethylacetamide, dioxane, 1,2-dimethoxyethane, sulfolane, dichloroethane, chlorobenzene, nitrobenzene, dimethoxyethane, diethylene glycoldimethylether, diethylene glycoldiethylether, dimethylene glycoldimethylether, trimethylene glycoldimethylether, tetraethylene glycoldimethylether, polyethylene glycoldimethylether, triethylene glycoldimethylether, and triethylene glycoldiethylether, but embodiments are not limited thereto, and any material that is electrochemically stable within a driving voltage range of an electrochemical mirror and available as a solvent in the art may be used.

The polymer in the electrolyte may improve a viscosity and stability of the electrolyte. The polymer may be polyvinylbutyral (PVB), polyvinylidene fluoride (PVDF), polytetrafluoroethylene (PTFE), vinylidene fluoride/hexafluoropropylenecopolyer (PVDF-HFP), vinylidene fluoride/tetrafluoroethylene co-polyer (PVDF-TFE), a Pullulan resin, a polyvinylalcohol-based cyano resin (PVA-CN), or a combination thereof, but embodiments are not limited thereto, and any material that is stable within a driving voltage range of an electrochemical mirror and available in the art may be used. An amount of the polymer may be in a range of about 0.1 wt % to about 10 wt %, about 0.5 wt % to about 10 wt %, about 1 wt % to about 10 wt %, about 1 wt % to about 8 wt %, about 3 wt % to about 7 wt %, or about 4 wt % to about 6 wt %, based on the total weight of the electrolyte.

A switching speed of switching from a transmission mode to a reflection mode of the electrochemical mirror using the electrolyte including the hydrophilic inorganic particles may increase 10% or more, 15% or more, 20% or more, 30% or more, 35% or more, 40% or more, 45% or more, 50% or more, or 100% or more, compared to the switching speed of an electrochemical mirror includes an electrolyte that is free of the hydrophilic inorganic particles.

Also, the electrochemical mirror using the electrolyte including the hydrophilic inorganic particles does not form a non-stripping defect such as a dead metal layer on the first electrode or the second electrode after 1000 cycles of mirrorizing switching within a voltage range of about −3.0 V to about 0.5 V.

According to another exemplary embodiment, a method of preparing an electrochemical mirror will be described with reference to the drawings.

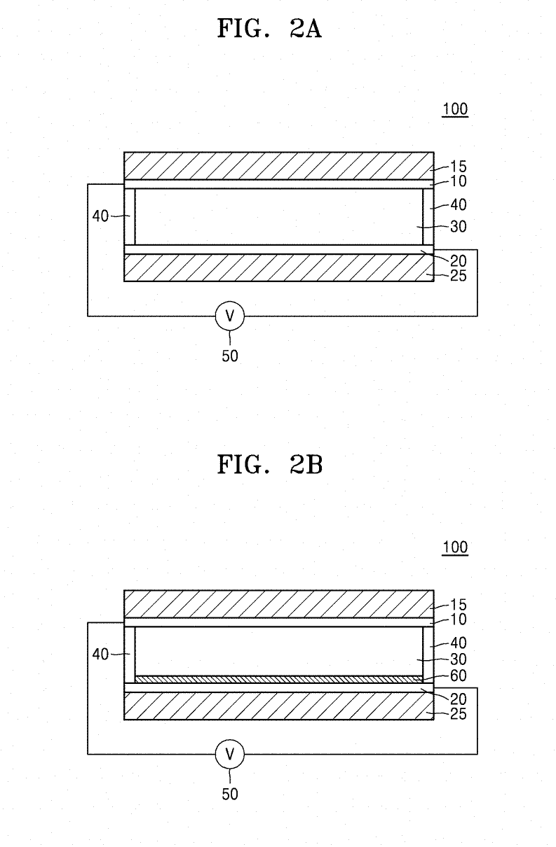

Referring to FIGS. 2A and 2B, first, a pair of a first substrate 15 and a second substrate 25, is provided. A pair of a first electrode 10 and a second electrode 20, is disposed on a surface of the first substrate 15 and a surface of the second substrate 25 facing each other, respectively.

The first substrate 15 and the second substrate 25 may be a transparent substrate. Examples of the transparent substrates may include a polymer film of polyester, polyimide, polymethylmethacrylate, polystyrene, polypropylene, polyethylene, polyamide, nylon, polyvinyl chloride, polycarbonate, polyethersulfone, silicon resin, polyacetal resin, fluorine resin, cellulose derivatives, or polyolefin; a plate-like substrate; and a glass substrate. A transparent substrate denotes a substrate having a transmittance of 50% or higher, 60% or higher, 70% or higher, 80% or higher, 90% or higher, 95% or higher, 97% or higher, or 99% or higher, with respect to visible light. In particular, the transparent substrate may be a glass substrate. The transparent substrate may be a flexible substrate.

The first electrode 10 and the second electrode 20 may be a transparent electrode. The transparent electrode is not limited to a particular material as long as it is transparent and has conductivity. The transparent electrode may include metal or a metal oxide such as indium tin oxide (ITO), indium zinc oxide (IZO), fluorine-doped tin oxide (FTO), indium oxide, zinc oxide, platinum, gold, silver, rhodium, copper, chrome, carbon, aluminum, silicon, amorphous silicon, bismuth silicon oxide (BSO), a composite thereof, an alloy thereof, or a combination thereof. The transparent electrode may include a conductive polymer of polythiophene, polypyrrole, polyaniline, polyacetylene, polyparaphenylene, polycelenophenylene, a mixture thereof, or a composite thereof. In particular, ITO may be used as a transparent electrode. A surface resistance of the transparent electrode may be 100Ω/□ or less, 50Ω/□ or less, 30Ω/□ or less, or 10Ω/□ or less, wherein Ω/□ means ohm per square, but the lower the surface resistance of an electrode, the better. A thickness of the transparent electrode may be in a range of about 0.1 μm to about 20 μm, but exemplary embodiments are not limited thereto, and the thickness may be selected within a range that provides an electrochemical mirror having an excellent performance.

A distance between the first electrode 10 and the second electrode 20 may be in a range of about 1 μm to about 10 mm, about 1 μm to about 1 mm, about 10 μm to about 800 μm, about 100 μm to about 600 μm, or about 200 μm to about 400 μm, but embodiments are not limited thereto, and the distance may be any distance as long as a depositable metal may be sufficiently deposited by a voltage applied between the electrodes.

A method of disposing the first electrode 10 and the second electrode 20 on a substrate may be sputtering, photolithography, electroplating, electroless plating, or printing, but exemplary embodiments are not limited thereto, and any method that disposes conductive electrodes on a substrate may be used.

An electrolyte 30 is disposed between the first electrode 10 and the second electrode 20, and the electrolyte 30 may be sealed by using a protection layer 40.

A power supply device 50 capable of applying a voltage may be connected between the first electrode 10 and the second electrode 20, thereby completing manufacture of an electrochemical mirror of a transmission mode.

Referring to FIG. 2B, when a voltage between the first electrode 10 and the second electrode 20 is applied from the power source device 50, a depositable metal is deposited on the second electrode 20, and thus a mirror layer 60 is formed on the second electrode 20, and an electrochemical mirror 100 may be in a reflection mode. Thereafter, when the voltage applied between the first electrode 10 and the second electrode 20 is released, or when a voltage of an opposite potential is applied between the first electrode 10 and the second electrode 20, a metal of the mirror layer 60 dissolves and thus the electrochemical mirror 100 may be in the transmission mode shown in FIG. 2A again. A reflection mode and a transmission mode of the electrochemical mirror 100 may be selectively switched by controlling a voltage applied from the power source device 50.

As used herein, in the expressions regarding the number of carbons, i.e., a capital “C” followed by a number, for example, “C1-C20”, “C3-C20”, or the like, the number such as “1”, “3”, or “20” following “C” indicates the number of carbons in a particular functional group. That is, a functional group may include from 1 to 20 carbon atoms. For example, a “C1-C4 alkyl group” refers to an alkyl group having 1 to 4 carbon atoms, such as CH₃—, CH₃CH₂—, CH₃CH₂CH₂—, (CH₃)₂CH—, CH₃CH₂CH₂CH₂—, CH₃CH₂CH(CH₃)—, and (CH₃)₃C—.

As used herein, the terms “alkyl group” or “alkylene group” refers to a branched or unbranched aliphatic hydrocarbon group. For example, the alkyl group may be substituted or not. Non-limiting examples of the alkyl group are a methyl group, an ethyl group, a propyl group, an isopropyl group, a butyl group, an isobutyl group, a tert-butyl group, a pentyl group, a hexyl group, a cyclopropyl group, a cyclopentyl group, a cyclohexyl group, and a cycloheptyl group, each of which may be optionally substituted or not. In some exemplary embodiments, the alkyl group may have 1 to 6 carbon atoms. For example, a C1-C6 alkyl group may be a methyl group, an ethyl group, a propyl group, an isopropyl group, a butyl group, an iso-butyl group, a sec-butyl group, a pentyl group, a 3-pentyl group, or a hexyl group, but embodiments are not limited thereto. The “alkylene group” is an “alkyl group” having at least 2 bonding sites.

As used herein, the term “cycloalkyl group” refers to a carbocyclic ring or ring system that is fully saturated. For example, the “cycloalkyl group” may refer to a cyclopropyl group, a cyclobutyl group, a cyclopentyl group, or a cyclohexyl group.

As used herein, the terms “aryl group” or “arylene group” refers to an aromatic ring or ring system (i.e., a ring fused from at least two rings, which shares two or more adjacent carbon atoms) of at least two ring including only carbon atoms in its backbone. When the aryl group is a ring system, each ring in the ring system may be aromatic. Non-limiting examples of the aryl group are a phenyl group, a biphenyl group, a naphthyl group, a phenanthrenyl group, and a naphthacenyl group. These aryl groups may be substituted or not. The “arylene group” is an “aryl group” having at least 2 bonding sites.

As used herein, the term “heteroaryl group” or “heteroarylene group” refers to an aromatic ring system with one or plural fused rings, in which at least one member of a ring is a heteroatom, i.e., not carbon. In the fused ring system, at least one heteroatom may be in one ring. For example, the heteroatom may be oxygen, sulfur, or nitrogen, but exemplary embodiments are not limited thereto. Non-limiting examples of the heteroaryl group are a furanyl group, a thienyl group, an imidazolyl group, a quinazolinyl group, a quinolinyl group, an isoquinolinyl group, a quinoxalinyl group, a pyridinyl group, a pyrrolyl group, an oxazolyl group, and an indolyl group. The “heteroarylene group” is an “heteroaryl group” having at least 2 bonding sites.

As used herein, the terms “heterocycloalkyl group” or “heterocycloalkylene group” refers to a non-aromatic ring or a ring system including at least one heteroatom in its cyclic backbone. The “heterocycloalkylene group” is an “heterocycloalkyl group” having at least 2 bonding sites.

As used herein, the term “halogen” refers to a stable atom belonging to Group 17 of the periodic tables of elements, for example, fluorine, chlorine, bromine, or iodine. For example, the halogen atom may be fluorine and/or chlorine.

As used herein, a substituent may be derived by substitution of at least one hydrogen atom in an unsubstituted mother group with another atom or a functional group. Unless stated otherwise, a substituted functional group refers to a functional group substituted with at least one substituent selected from a C1-C40 alkyl group, a C2-C40 alkenyl group, a C3-C40 cycloalkyl group, a C3-C40 cycloalkenyl group, a C1-C40 alkyl group, and a C7-C40 aryl group. When a functional group is “optionally” substituted, it means that the functional group may be substituted with such a substituent as listed above.

Hereinafter, exemplary embodiments will be described in more detail with reference to Examples. However, these Examples are provided for illustrative purposes only, and the scope of the exemplary embodiments is not intended to be limited by these Examples.

(Preparation of Electrochemical Mirror)

### Example 1: 1 wt % of SiO₂ Containing —OH Group

50 mM of AgNO₃ as a first metal compound, 10 mM of CuBr₂ as a second metal compound, 250 mM of LiBr as a supporting salt, 5 wt % of polyvinylburyral (PVB) (grade BH-3, available from Sekisui Co.) as a polymer, and 1 wt % of SiO₂ (grade OX50, available from Evonik) having —OH group on a surface thereof as hydrophilic inorganic particles were added to dimethylsulfoxide (DMSO) as a solvent to prepare an electrolyte solution. An average particle diameter of primary particles of SiO₂ having —OH group on a surface thereof was about 40 nm. Therefore, hydrophilic inorganic particles of SiO₂ having —OH group on a surface thereof are hydrophilic inorganic nanoparticles.

The electrolyte solution was injected between two transparent substrates coated with an indium tin oxide (ITO) thin film, where the substrates faced each other, and the resultant was sealed and connected to a power device to complete an electrochemical mirror. A gap between the two ITO thin films facing each other was 300 μm.

### Example 2: 2 wt % of SiO₂ Containing —OH Group

An electrochemical mirror was prepared in the same manner as in Example 1, except that 50 mM of AgNO₃ as a first metal compound, 10 mM of CuBr₂ as a second metal compound, 250 mM of LiBr as a supporting salt, 5 wt % of PVB (grade BH-3, available from Sekisui Co.) as a polymer, and 2 wt % of SiO₂ (grade OX50, available from Evonik) having —OH group on a surface thereof as hydrophilic inorganic particles were added to DMSO as a solvent to prepare an electrolyte solution.

### Example 3: 1 wt % of Al₂O₃ Containing Hydrophilic Group

An electrochemical mirror was prepared in the same manner as in Example 1, except that 50 mM of AgNO₃ as a first metal compound, 10 mM of CuBr₂ as a second metal compound, 250 mM of LiBr as a supporting salt, 5 wt % of PVB (grade BH-3, available from Sekisui Co.) as a polymer, and 1 wt % of Al₂O₃ (grade Alu C from Evonik) having hydrophilic group on a surface thereof as hydrophilic inorganic particles were added to DMSO as a solvent to prepare an electrolyte solution.

### Example 4: 1 wt % of Mixture of 1:5 of Al₂O₃ and SiO₂ Containing Hydrophilic Group

An electrochemical mirror was prepared in the same manner as in Example 1, except that 50 mM of AgNO₃ as a first metal compound, 10 mM of CuBr₂ as a second metal compound, 250 mM of LiBr as a supporting salt, 5 wt % of PVB (grade BH-3, available from Sekisui Co.) as a polymer, and 1 wt % of a mixture of Al₂O₃ and SiO₂ at a weight ratio of 1:5 (grade COK84, available from Evonik) having a hydrophilic group on a surface thereof as hydrophilic inorganic particles were added to DMSO as a solvent to prepare an electrolyte solution.

### Example 5: 1 wt % of Al₂O₃-Doped SiO₂ Containing —OH Group

An electrochemical mirror was prepared in the same manner as in Example 1, except that 50 mM of AgNO₃ as a first metal compound, 10 mM of CuBr₂ as a second metal compound, 250 mM of LiBr as a supporting salt, 5 wt % of PVB (grade BH-3, available from Sekisui Co.) as a polymer, and 1 wt % of Al₂O₃-doped SiO₂ (grade MOX170, available from Evonik) having —OH group on a surface thereof as hydrophilic inorganic particles were added to DMSO as a solvent to prepare an electrolyte solution.

### Example 6: 1 wt % of SiO₂ Containing —OH Group and Using CuF₂

An electrochemical mirror was prepared in the same manner as in Example 1, except that 50 mM of AgNO₃ as a first metal compound, 10 mM of CuF₂ as a second metal compound, 250 mM of LiBr as a supporting salt, 5 wt % of PVB (grade BH-3, available from Sekisui Co.) as a polymer, and 1 wt % of SiO₂ (grade OX50, available from Evonik) having —OH group on a surface thereof as hydrophilic inorganic particles were added to DMSO as a solvent to prepare an electrolyte solution.

### Comparative Example 1: 0 wt % of SiO₂ Containing —OH Group

An electrochemical mirror was prepared in the same manner as in Example 1, except that 50 mM of AgNO₃ as a first metal compound, 10 mM of CuBr₂ as a second metal compound, 250 mM of LiBr as a supporting salt, and 5 wt % of PVB (grade BH-3, available from Sekisui Co.) as a polymer were added to DMSO as a solvent to prepare an electrolyte solution.

### Comparative Example 2: 0 mM of CuBr₂

An electrochemical mirror was prepared in the same manner as in Example 1, except that 50 mM of AgNO₃ as a first metal compound, 250 mM of LiBr as a supporting salt, 5 wt % of PVB (grade BH-3, available from Sekisui Co.) as a polymer, and 1 wt % of SiO₂ (grade OX50, available from Evonik) having —OH group on a surface thereof as hydrophilic inorganic particles were added to DMSO as a solvent to prepare an electrolyte solution.

### Evaluation Example 1: Evaluation of Dispersibility of Inorganic Particles

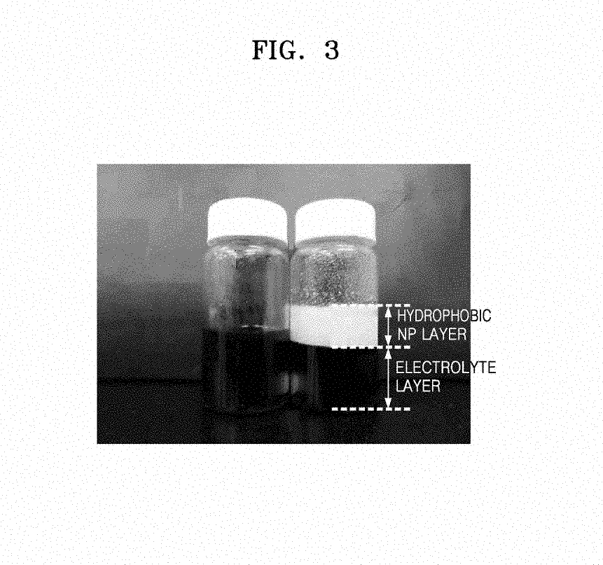

50 mM of AgNO₃ as a first metal compound, 10 mM of CuBr₂ as a second metal compound, 250 mM of LiBr as a supporting salt, 5 wt % of PVB (grade BH-3, available from Sekisui Co.) as a polymer, and 1 wt % of SiO₂ (grade OX50, available from Evonik) having —OH group on a surface thereof as hydrophilic inorganic particles were added to DMSO as a solvent to prepare a first solution. In FIG. 3, a vial on the left is the first solution. In the first solution, the hydrophilic inorganic particles maintained a dispersed state.

A second solution was prepared in the same manner as in the preparation of the first solution, except that the hydrophilic inorganic particles were changed to inorganic particles SiO₂ (grade R202 or grade RY50, available from Evonik) treated with a hydrophobic group (—CH₃). In FIG. 3, a vial on the right is the second solution. In the second solution, the hydrophobic inorganic particles were not dispersed in an electrolyte solution, and thus the second solution had phase separation of two phases.

Therefore, it was confirmed that the hydrophobic inorganic particles may not be used in an electrochemical mirror.

### Evaluation Example 2: Reversibility Evaluation-Cyclic Voltammetry Measurement

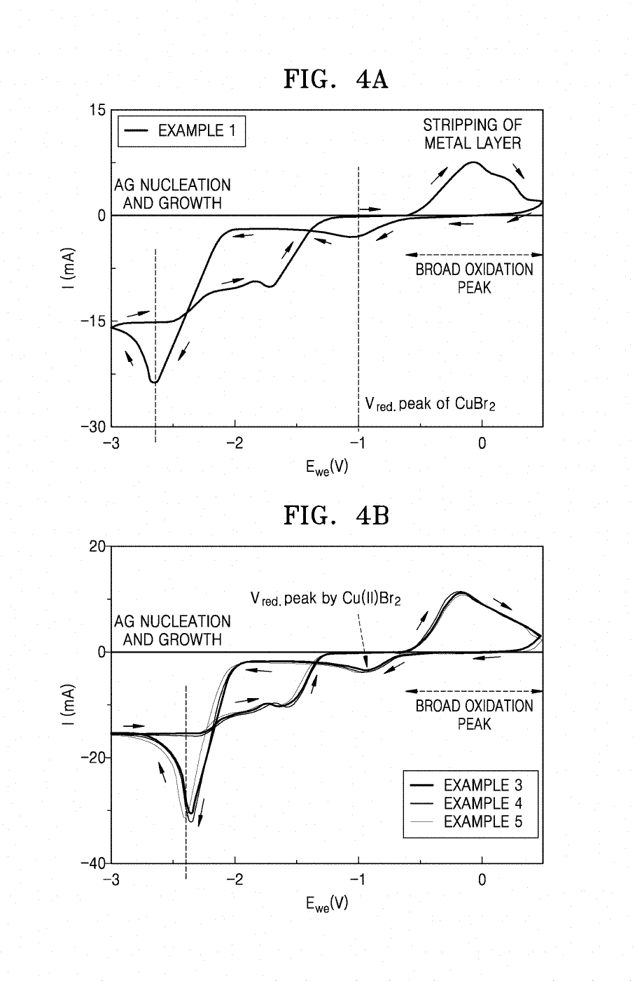

The electrochemical mirrors prepared in Examples 1, 3, 4, and 5 were repeatedly scanned by using a cyclic voltammetry method within a voltage range of about −3 V to about +0.5 V at a rate of 20 mV/sec to obtain cyclic voltammograms, and the results are shown in FIGS. 4A and 4B. As shown in FIGS. 4A and 4B, as a voltage of a working electrode changed to −3.0 V, a reduction peak of Cu ion, which was a second metal, was observed around −1.0 V, and a reduction peak of Ag ion, which was a first metal, was observed in a range of about −2.4 V to about −2.6 V. Also, it was confirmed by the naked eye that the electrochemical mirror was in a reflection mode. Subsequently, as a voltage of the working electrode changed to an opposite direction up to +0.5 V, an oxidation peak, in which Ag and Cu in the mirror layer dissolved, was observed in a range of about −0.5 V to about 0.5 V. Also, it was confirmed by the naked eye that the electrochemical mirror was in a transmission mode. Since an oxidation current value is smaller than a reduction current value, it was confirmed that oxidation readily occurred compared to reduction.

In spite of the working electrode repeatedly circulated within a voltage range of −3 V to +0.5 V, changes in positions and intensities of reduction and oxidation peaks of the cyclic voltammograms were insignificant. That is, oxidation and reduction in the electrochemical mirror occurred reversibly without a side reaction. Therefore, it was confirmed that reversibility of an electrochemical mirror using an electrolyte including hydrophilic inorganic nanoparticles was excellent.

### Evaluation Example 3: Reversibility Evaluation-Impedance Measurement

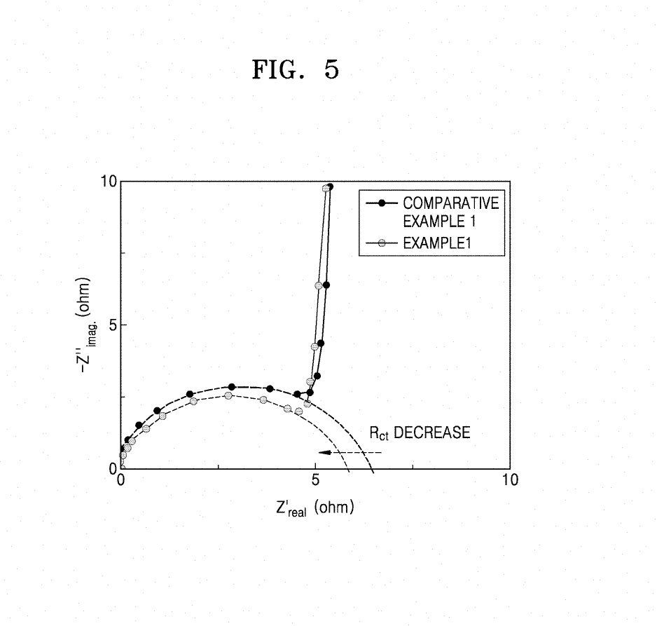

Impedances of the electrochemical mirrors prepared in Example 1 and Comparative Example 1 were measured in a reflection mode where a mirror layer of −3.0 V was formed by using a 2-probe method with an impedance analyzer (available from Biologic Co.). A frequency range was about 200 kHz to about 500 MHz. A Nyquist plot with respect of the results of the impedance measurement is shown in FIG. 5. In the Nyquist plot of FIG. 5, black dots are related to the electrochemical mirror of Comparative Example 1, and gray dots are related to the electrochemical mirror of Example 1. In FIG. 5, a point of a right side of the semicircle extended to meet an X-axis corresponds to an interfacial resistance, i.e., a charge transfer resistance (Rct), at which an ion was reduced and turned into a metal. The lower the interfacial resistance, the easier ion transfer at an interface, which increases reversibility of an electrochemical reaction.

As shown in FIG. 5, the interfacial resistance of the electrochemical mirror of Example 1 using the electrolyte including hydrophilic inorganic particles decreased about 1.8Ω compared to that of the electrochemical mirror of Comparative Example 1 using an electrolyte not including hydrophilic inorganic particles. That is, reversibility of an electrochemical reaction at an interface of the electrochemical mirror of Example 1 improved compared to that of the electrochemical mirror of Comparative Example 1.

Also, such decrease in the interfacial resistance denotes that a mirror layer formed at an interface of the electrochemical mirror of Example 1 has a composition that is different from a composition of a mirror layer formed at an interface of the electrochemical mirror of Comparative Example 1, that is, the composition of the mirror layer formed at an interface of the electrochemical mirror of Example 1 is better in terms of ion transfer than that of the mirror layer formed at an interface of the electrochemical mirror of Comparative Example 1. Since the mirror layer of the electrochemical mirror of Example 1 further includes hydrophilic nanoparticles in addition to Cu metal and Ag metal, a composition of the mirror layer of the electrochemical mirror of Example 1 may be different from that of the mirror layer of Comparative Example 1 including only Cu metal and Ag metal. The hydrophilic nanoparticles together with Ag cations and Cu cations may form one coalescence layer on the mirror layer formed at an interface between an electrode and an electrolyte, due to an —OH group in the hydrophilic inorganic nanoparticles in the electrolyte having attractive interaction with the Ag cations and Cu cations.

### Evaluation Example 4: Evaluation of Mirrorizing Speed

A period of time for an object located behind an electrochemical mirror to completely disappear (i.e., a period of time for converting a transmission mode to a reflection mode, which is a mirrorizing time) was measured after applying a voltage of −3.0 V with respect to a working electrode of each of the electrochemical mirrors prepared in Examples 1 to 5 and Comparative Example 1.

The electrochemical mirror of Example 1 was completely converted to a reflection mode after 10 seconds from a point of time when a voltage of −3.0 V was applied to the electrochemical mirror in a transmission mode to which a voltage had not previously been applied.

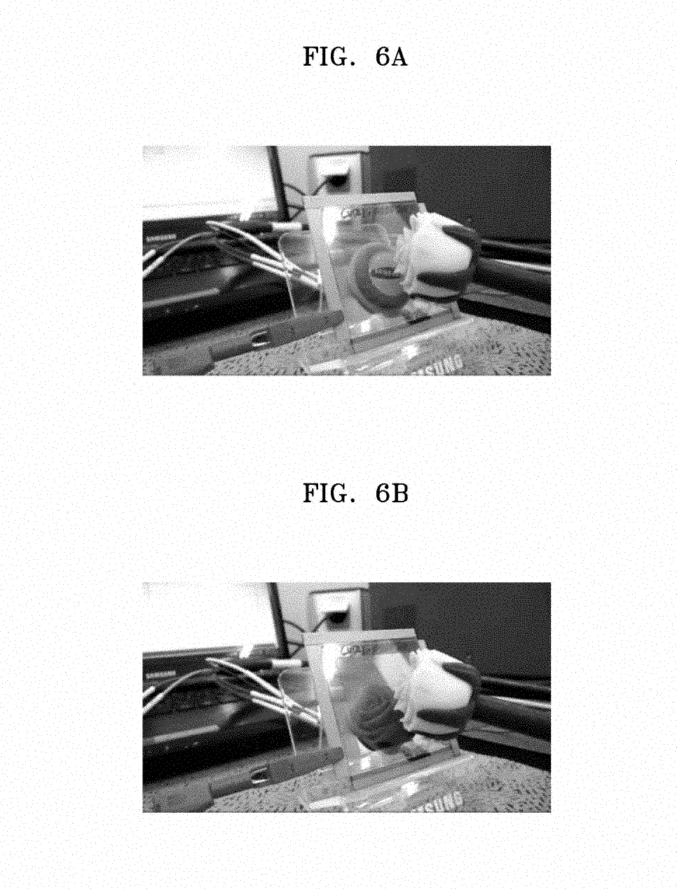

FIG. 6A is a view illustrating the electrochemical mirror of Example 1 in a transmission mode, to which a voltage had not been applied, and a circular object located behind the mirror was clearly seen. Although not shown in the drawings, the electrochemical mirrors of Example 2 and Comparative Example 1 in a transmission mode were the same.

FIG. 6B is a view illustrating the electrochemical mirror of Example 1, 10 seconds after being applied with a voltage of −3.0 V, which has been completely converted to a reflection mode and which clearly reflected a rose at its front, and the circular object located behind the mirror was not seen at all.

Although not shown in the drawings, the electrochemical mirror of Example 2 was almost converted to a reflection mode after 5 seconds and was completely converted to a reflection mode after 10 seconds.

Although not shown in the drawings, the electrochemical mirrors of Examples 3, 4, and 5 were completely converted to a reflection mode in 10 to 15 seconds, respectively.

Although not shown in the drawings, the electrochemical mirror of Comparative Example 1 was not completely converted to a reflection mode even after 30 seconds, and an image of an object located behind the mirror was partially seen.

Therefore, mirrorizing switching speeds of the electrochemical mirrors of Examples 1 to 5 improved at least 50% compared to that of the electrochemical mirror of Comparative Example 1. The switching speed is a time for switching from a transmission mode to a reflection mode, which was defined by a period of time elapsed for an object behind the mirror to become completely invisible.

### Evaluation Example 5: Evaluation of Cycle Life

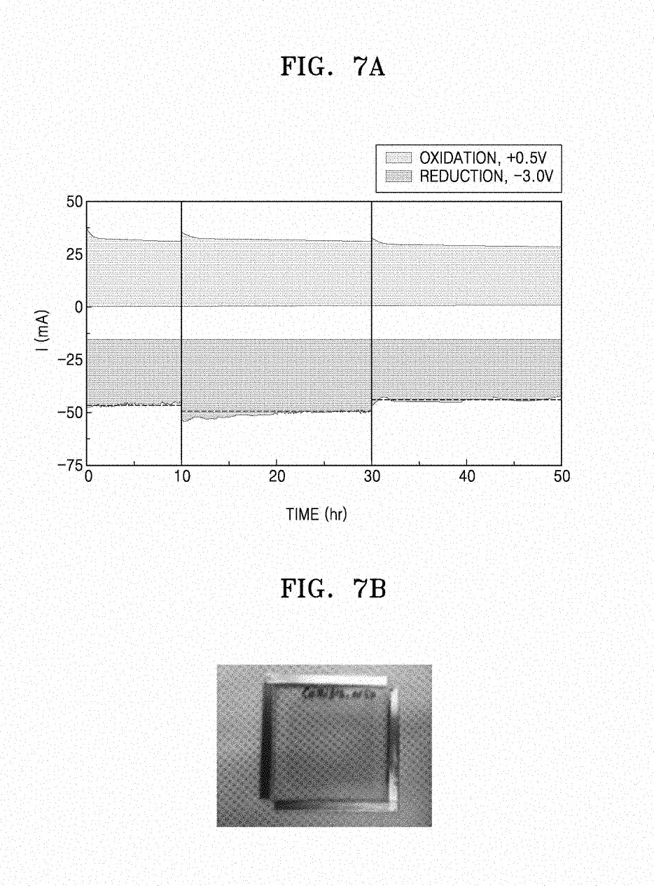

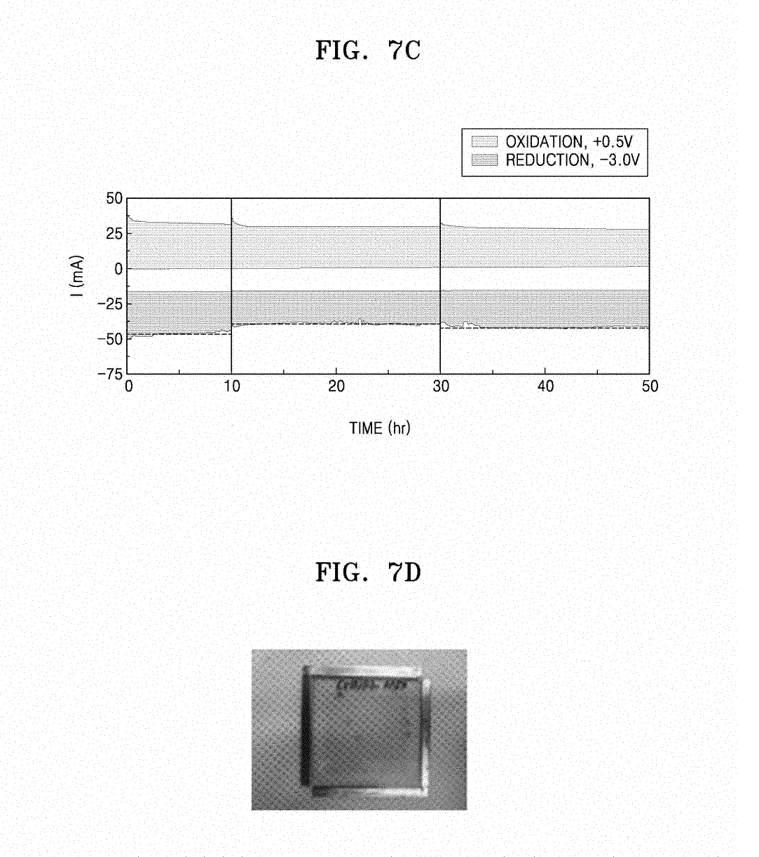

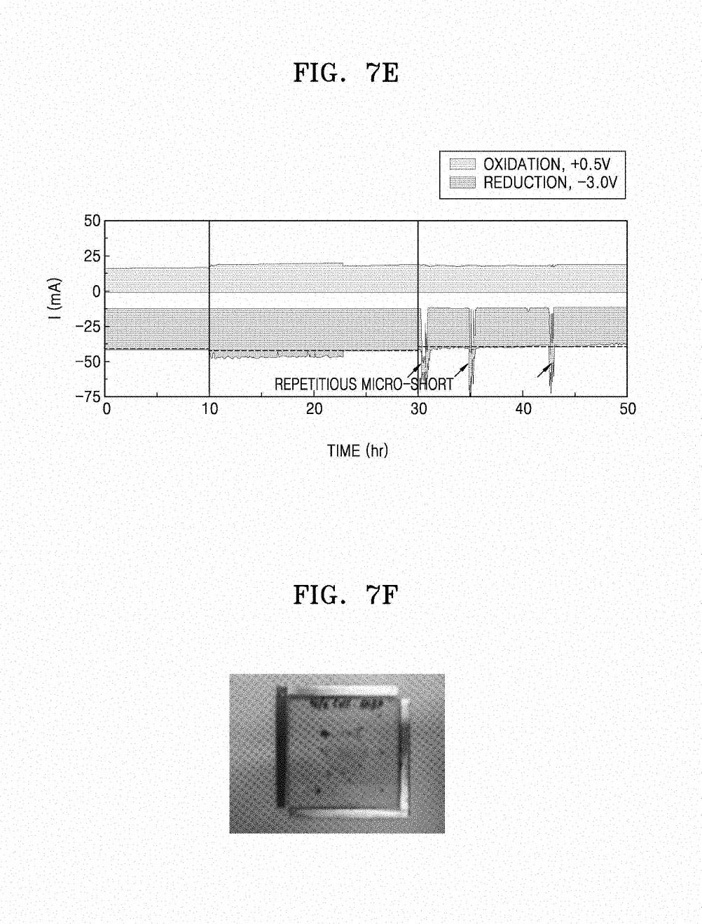

As one cycle of switching, a voltage of −3.0 V was applied to a working electrode of the electrochemical mirror prepared in Example 1 for 1 minute to convert the mirror into a reflection mode, and then a voltage of +0.5 V was applied to the mirror for 2 minutes to convert the mirror back into a transmission mode. This cycle was repeated 1000 times, and changes in a reduction current and an oxidation current according to time are shown in FIG. 7A, and a state of an electrochemical surface in the transmission mode after the 1000 cycles is shown in FIG. 7B. In the same manner, the results regarding Example 6 are shown in FIGS. 7C and 7D, and the results regarding Comparative Example 2 are shown in FIGS. 7E and 7F.

As shown in FIG. 7A, the electrochemical mirror of Example 1 had a reduction current and an oxidation current that remained stable during the 1000 cycles. Also, as shown in FIG. 7B, since there was no chemical reaction or irreversible electrochemical reaction, the electrochemical mirror in a transmission mode after the 1000 cycles was transparent.

As shown in FIG. 7C, the electrochemical mirror of Example 6 had a reduction current and an oxidation current that remained stable during the 1000 cycles. As shown in FIG. 7D, air bubbles were found to be formed in the electrolyte due to a chemical side reaction in the electrochemical mirror in a transmission mode after the 1000 cycles. However, since there was no irreversible electrochemical reaction, non-stripping defects fixed on the electrode were not observed.

As shown in FIG. 7E, in the electrochemical mirror of Comparative Example 2, a reduction current and an oxidation current did not remain stable during the 1000 cycles and had repeated micro-shorts. Also, as shown in FIG. 7F, air bubbles were found to be formed in the electrolyte due to a chemical side reaction in the electrochemical mirror in a transmission mode after the 1000 cycles, and non-stripping defects fixed on the electrode were observed.

Therefore, the electrochemical mirrors of Examples 1 and 6 had improved reversibility of electrochemical reactions and improved lifespan characteristics compared to those of the electrochemical mirror of Comparative Example 2.

Also, the electrochemical mirror of Example 1 had improved reversibility of electrochemical reactions and improved lifespan characteristics compared to those of the electrochemical mirror of Example 6.

### Evaluation Example 6: Evaluation of Mirror Uniformity

While evaluating lifespan characteristics of the electrochemical mirrors of Examples 1 and 6 and Comparative Example 2 in the same manner as in Evaluation Example 5, the electrochemical mirrors were each converted to a reflection mode by applying a voltage of −3.0 V for 1 minute after 600 cycles of switching, and then uniformity of a mirror layer of the electrochemical mirrors in a reflection mode was evaluated.

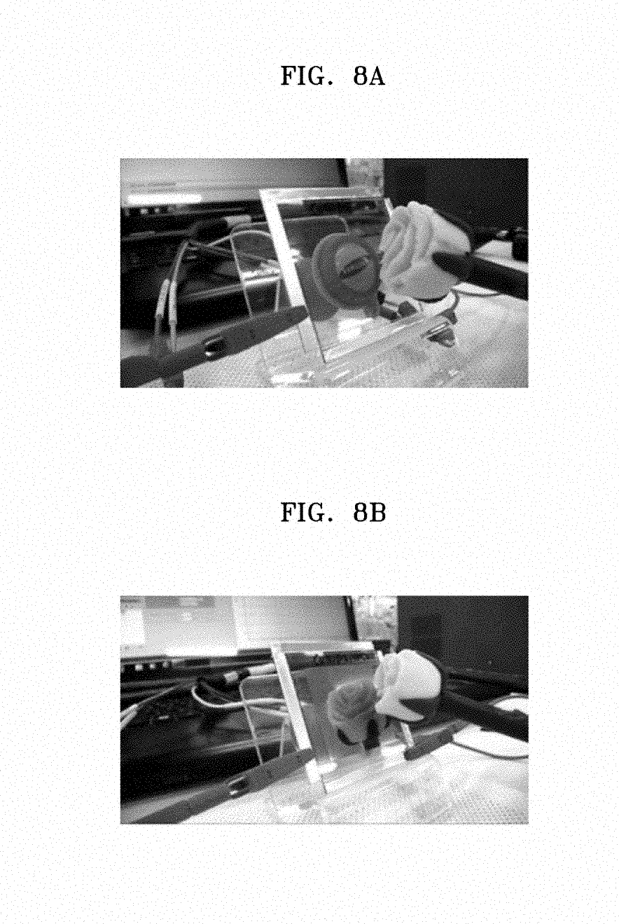

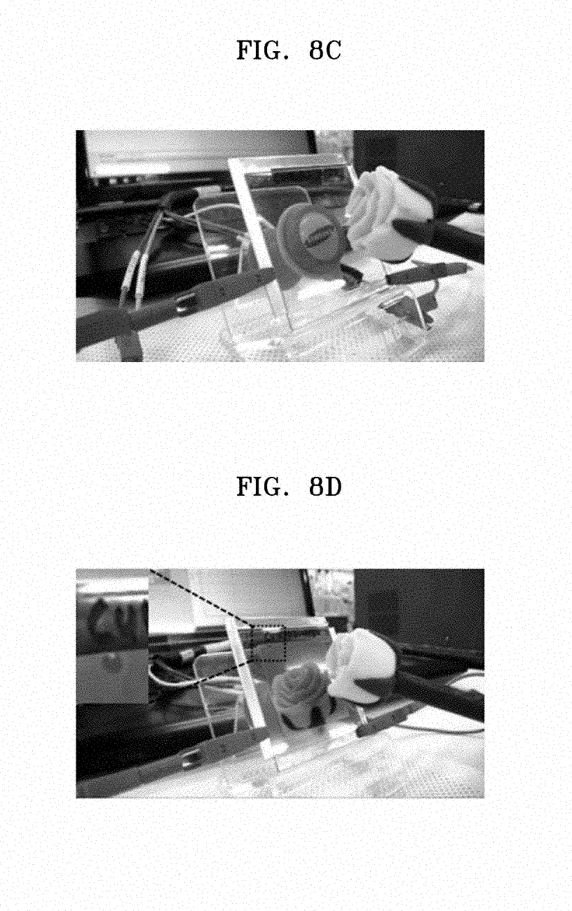

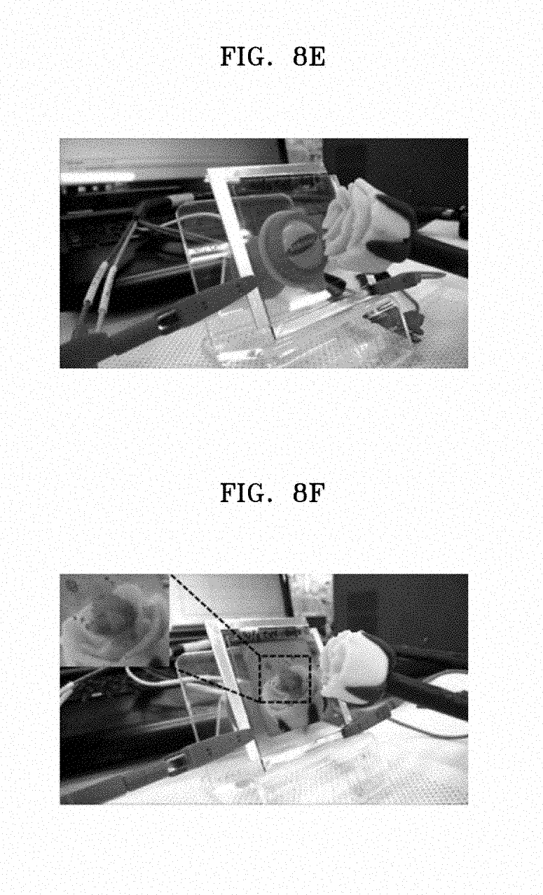

As shown in FIG. 8A, a circular object behind the electrochemical mirror of Example 1 was clearly visible in an initial transmission mode.

As shown in FIG. 8B, the electrochemical mirror of Example 1 clearly reflected a rose at the front of the mirror in a reflection mode after the 600 cycles, and thus it was confirmed that the uniform mirror layer was maintained.

As shown in FIG. 8C, a circular object behind the electrochemical mirror of Example 6 was clearly visible in an initial transmission mode.

As shown in FIG. 8D, the electrochemical mirror of Example 6 clearly reflected a rose at the front of the mirror in a reflection mode after the 600 cycles, but air bubbles were observed in an upper left portion of the mirror.

As shown in FIG. 8E, a circular object behind the electrochemical mirror of Comparative Example 2 was clearly visible in an initial transmission mode.

As shown in FIG. 8F, the electrochemical mirror of Comparative Example 2 did not clearly reflect a rose at the front of the mirror in a reflection mode after the 600 cycles, and a plurality of defects were observed on the surface of the mirror.

Therefore, the electrochemical mirrors of Examples 1 to 6 had improved uniformity of a mirror layer due to improvement of reversibility of electrochemical reactions, compared to that of the electrochemical mirror of Comparative Example 2.

Also, uniformity of a mirror layer of the electrochemical mirror of Example 1 improved compared to that of the electrochemical mirror of Example 6.

As described above, according to one or more exemplary embodiments, when an electrolyte including hydrophilic inorganic particles improve reversibility of electrochemical reactions involved in switching of an electrochemical mirror, a switching speed, mirror uniformity, and lifespan characteristics of the electrochemical mirror may improve.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. An electrochemical mirror comprising:
a first electrode;
a second electrode; and
an electrolyte between the first electrode and the second electrode,
wherein the electrolyte comprises:
hydrophilic inorganic particles;
a first metal compound comprising a first metal; and
a second metal compound comprising a second metal different from the first metal.

2. The electrochemical mirror of claim 1, further comprising a hydrophilic functional group that is positioned on one of a surface of the hydrophilic inorganic particles and a first surface of the first electrode and a second surface of the second electrode.

3. The electrochemical mirror of claim 2, wherein the hydrophilic functional group comprises at least one selected from among:
—OH, —(C═O)—OH,
—(C═O)—H, —NH₂,
—(C═O)—NH₂,
—R—OH,
—R—(C═O)—OH,
—R—(C═O)—H,
—R—NH₂, and
—R—(C═O)—NH₂,
where R is one from among:
an unsubstituted or substituted C1-C20 alkylene group,
an unsubstituted or substituted C6-C20 arylene group,
an unsubstituted or substituted C3-C20 heteroarylene group,
an unsubstituted or substituted C4-C20 cycloalkylene group, and
an unsubstituted or substituted C3-C20 heterocycloalkylene group.

4. The electrochemical mirror of claim 1, wherein the hydrophilic inorganic particles comprise at least one metal oxide represented by a formula, a composite thereof, or a combination thereof,
wherein the formula comprises: MₐO_{b}
where 1≤a≤2, 1≤b≤4, and M is at least one element that belongs to Group 2 to Group 14 of a periodic table.

5. The electrochemical mirror of claim 1, wherein the hydrophilic inorganic particles include at least one metal oxide represented by a formula, a composite thereof, or a combination thereof,
wherein the formula comprises:
M′_{c}O_{d}
where 1≤c≤2, 1≤d≤3, and M′ is at least one element selected from among Si, Al, Ti, Mg, Ba, Zr, and Zn.

6. The electrochemical mirror of claim 5, wherein the hydrophilic inorganic particles comprise SiO₂, TiO₂, Mg(OH)₂, MgO₂, ZrO₂, ZnO, Al₂O₃, BaTiO₃, a mixture thereof, a composite thereof, or a combination thereof.

7. The electrochemical mirror of claim 1, wherein the hydrophilic inorganic particles comprise nanoparticles having an average particle diameter in a range of about 5 nm to about 200 nm or an agglomerate of nanoparticles having an average particle diameter in a range of about 50 nm to about 50 μm.

8. The electrochemical mirror of claim 1, wherein a surface area of the hydrophilic inorganic particles is 150 m²/g or less.

9. The electrochemical mirror of claim 1, wherein an amount of the hydrophilic inorganic particles is in a range of about 0.1 wt % to about 20 wt % based on a total weight of the electrolyte.

10. The electrochemical mirror of claim 1, wherein the hydrophilic inorganic particles are dispersed in the electrolyte, and wherein the hydrophilic inorganic particles are involved in reduction or oxidation, in the electrolyte, of at least one selected from among the first metal and the second metal.

11. The electrochemical mirror of claim 1, further comprising a mirror layer positioned on one of the first electrode and the second electrode, by a deposition of at least one of the first metal and the second metal, wherein the mirror layer comprises the hydrophilic inorganic particles.

12. The electrochemical mirror of claim 1, further comprising a coating layer positioned on a surface of at least one selected from among the first electrode and the second electrode, wherein the coating layer comprises a hydrophilic functional group.

13. The electrochemical mirror of claim 1, wherein the first metal compound is an ionic compound comprising:
a cation of the first metal which is at least one selected from among Ag, Au, Mg, Ni, Bi, Cr, Cr, Sr, and Al; and
a non-halogen anion.

14. The electrochemical mirror of claim 1, wherein the second metal compound is a halide of the second metal and wherein an absolute value of a reduction potential of the second metal is smaller than an absolute value of a reduction potential of the first metal.

15. The electrochemical mirror of claim 14, wherein the second metal compound comprises at least one selected from among Cu, Ca, Sr, Fe, and Sn.

16. The electrochemical mirror of claim 14, wherein the second metal compound comprises at least one selected from among CuBr₂, CuCl₂, and CuF₂.

17. The electrochemical mirror of claim 1, wherein the electrolyte comprises at least one selected from among a halogen salt, a polymer, and a solvent.

18. The electrochemical mirror of claim 17, wherein the halogen salt comprises at least one selected from among:
a halogen solid salt comprising at least one cation selected from among an alkali metal and an ammonium-based cation; and
a halogen ionic liquid comprising at least one selected from among a pyrrolidinium-based cation, a pyridinium-based cation, a piperidinium-based cation, and an imidazolium-based cation.

19. The electrochemical mirror of claim 17, wherein the halogen salt comprises at least one selected from among: LiBr, NaBr, KBr, tetrabutylammoniumbromide (TBABr), tetraethylammoniumbromide (TEABr), 1-ethyl-methylimidazoliumbromide (EMIMBr), 1-methyl-4-hexylimidazoliumbromide (MHIMBr), 1-butyl-4-ethylimidazoliumbromide (BEIMBr), 1-butyl-4-hexylimidazoliumbromide (BHIMBr), 1-butyl-4-dodecylimidazoliumbromide (BDIMBr), and N-butyl-methyl-pyrrolidiniumbromide (NBMPBr) and/or the solvent comprises at least one selected from among: water, dimethylsulfoxide (DMSO), propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, dimethylether, diethylether, γ-butyrolactone, dioxolane, 4-methyldioxolane, N,N-dimethylformamide, dimethylacetamide, dioxane, 1,2-dimethoxyethane, sulfolane, dichloroethane, chlorobenzene, nitrobenzene, dimethoxyethane, diethylene glycoldimethylether, diethylene glycoldiethylether, dimethylene glycoldimethylether, trimethylene glycoldimethylether, tetraethylene glycoldimethylether, polyethylene glycoldimethylether, and triethylene glycoldimethylether, and triethylene glycoldiethylether.

20. The electrochemical mirror of claim 1, wherein a switching speed between a reflection mode and a transmission mode of the electrochemical mirror and a cycle life of the electrochemical mirror are increased by at least 10% compared to the switching speed of another electrochemical mirror comprising the electrolyte free of the hydrophilic inorganic particles and/or the electrochemical mirror is free of non-stripping defects on the first electrode and the second electrode after 1000 cycles of switching of the electrochemical mirror between a reflection mode and a transmission mode within a voltage range of about −3.0 V to about 0.5 V.
